(19) United States
(12) Patent Application Publication
(10) Pub. No.: US 2009/0225085 A1
(43) Pub. Date: Sep. 10, 2009

(54) METHOD AND DEVICE FOR ENTERING TEXT

(76) Inventor: Jukka-Pekka Hyvarinen, Coppell, TX (US)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/989,376

(22) PCT Filed: Jul. 27, 2005
(86) PCT No.: PCT/IB2005/002529

§ 371 Date: Jan. 23, 2009

(51) Int. Cl. G06T 11/00

(52) U.S. Cl. 345/467; 345/169

(57) ABSTRACT

A text input method for use in an electronic device, comprising: changing, in response to a trigger within an input sequence being made by a user, from a first text input method to a second text input method, wherein the second text input method displays text corresponding to the input sequence including text corresponding to the trigger. A text input method for use on an electronic device comprising: searching, on the basis of an input sequence being made by a user, for words in a database that has a first condition and a second alternative condition; changing the condition of the database from the first condition to the second condition in response to a trigger within the input sequence; and displaying at least one word resulting from the search that includes text corresponding to the trigger.

### CROSS REFERENCE TO RELATED APPLICATIONS

This application is the U.S. National Stage of International Application Number PCT/IB05/002529 filed on Jul. 27, 2005 which was published in English on Feb. 1, 2007 under International Publication Number WO 2007/012912.

### FIELD OF THE INVENTION

Embodiments of the invention relate to a method and a device for entering text.

### DEFINITIONS

“string of alphanumeric characters” is a series of consecutive alphanumeric characters preceded by a space.
“word” is a string of alphanumeric characters that may be followed by a space.
“alphanumeric character” is any letter, numeral or character usable in an email address such as _, @ etc.

### BACKGROUND TO THE INVENTION

A problem with the use of a hand-portable electronic device is the process of entering text. For instance, in ordinary mobile telephones employing an ITU-T character keypad, each button in the keypad relates to several letters. A single button may, for instance, relate to the letters a, b and c. Pressing the button once produces the letter a, pressing the button twice within a short threshold period of time produces the letter b, and pressing the button three times within a short threshold period of time produces the letter c. Pressing the button twice slightly more slowly i.e. with a hiatus greater than a threshold produces two a's. It is rather slow to use a keyboard in such a manner; therefore, various methods for entering text which employ a 12 button character keyboard have been developed. One such a method uses predictive/disambiguating text software such as “T9” by Tegic Communications. The functionality of “T9” is described in U.S. Pat. No. 5,818,437 (Tegic Communications), titled “Reduced Keyboard Disambiguating Computer”, the contents of which are incorporated herein by reference.

For practical reasons, the standard database used for predictive text input is limited, and does not include all the words a user may want to use. This makes the use of predictive text input clumsy, particularly in the case of proper nouns, which present a typical set of words not included in the standard database.

### SUMMARY OF THE INVENTION

According to one embodiment of the invention as claimed, there is provided a text input method for use in an electronic device, comprising: changing, in response to a trigger within an input sequence being made by a user, from a first text input method to a second text input method, wherein the second text input method displays text corresponding to the input sequence including text corresponding to the trigger.

According to another embodiment of the invention as claimed, there is provided a computer readable memory stored with program instructions executable by a processor for: automatically changing, in response to a trigger within an input sequence being made by a user, a first text input method to a second text input method, wherein the second text input method displays text corresponding to the input sequence including text corresponding to the trigger.

According to another embodiment of the invention as claimed, there is provided an electronic device for user entry of text comprising: a user input device; a display; a processor; memory storing personal data, a database comprising words wherein at least some of the words in the database are taken from the stored personal data, and a set of processor instructions which cause the processor: to change, in response to a trigger within an input sequence being made by a user via the input device, from a first text input method to a second text input method, wherein the second text input method displays text corresponding to the input sequence including text corresponding to the trigger.

According to another embodiment of the invention as claimed, there is provided a text input method for use on an electronic device comprising: searching, on the basis of an input sequence being made by a user, for words in a database that has a first condition and a second alternative condition; changing the condition of the database from the first condition to the second condition in response to a trigger within the input sequence; and displaying at least one word resulting from the search that includes text corresponding to the trigger.

According to another embodiment of the invention as claimed, there is provided a computer readable memory stored with program instructions executable by a processor for: searching for words in the database on the basis of the input sequence being made by a user; changing the database in response to a predetermined trigger within an input sequence being made by a user; searching for words in the changed database on the basis of the input sequence being made by a user; and displaying at least one word resulting from the search that includes text corresponding to the trigger.

According to another embodiment of the invention as claimed, there is provided an electronic device for user entry of text comprising: a user input device; a display; a processor; memory storing personal data, a database comprising words wherein at least some of the words in the database are taken from the stored personal data, and a set of processor instructions which cause the processor: to change the database in response to a predetermined trigger within an input sequence being made by a user via the input device, to search for words in the database on the basis of the input sequence being made by the user via the user input device; and to display via the display at least one word resulting from the search that includes text corresponding to the trigger.

One aspect of the invention may provide a text input method for use in an electronic device, comprising: searching for words in a database on the basis of an input sequence being made by a user; and displaying at least one word resulting from the search, wherein at least some of the words in the database are taken from personal data stored on the device. Words taken from personal data stored on the device may be given a high priority. The priority of a word may control the likelihood that that word will result from a search and/or the order in which words resulting from a search are displayed.

This aspect of the invention may provide an electronic text input method comprising: augmenting a database using personal data stored on the device; searching for words in the augmented database on the basis of an input sequence being made by a user; and displaying at least one word resulting from the search.

This aspect of the invention may provide disambiguating software comprising computer program instruction for: augmenting a database using words taken from personal data stored on the device; searching for words in the database on the basis of an input sequence being made by a user; and displaying at least one word resulting from the search.

This aspect of the invention may provide a data structure, for use by disambiguating software located on a device, that associates with each of a plurality of key identifier sequences a set of words whose spellings correspond to the respective key identifier sequence, wherein at least some of the words are from personal data stored on the device.

This aspect of the invention may provide an electronic device for user entry of text comprising: a user input device; a display; a processor; memory storing personal data, a database comprising words wherein at least some of the words in the database are taken from the stored personal data, and a set of processor instructions which cause the processor: to search for words in the database on the basis of an input sequence being made by a user via the user input device; and to display via the display at least one word resulting from the search,

Another aspect of the invention may provide a text input method for use in an electronic device, the method comprising: changing, in response to a trigger within an input sequence being made by a user, from using a first database for text input to using a second database for text input. The text input method may display text corresponding to the input sequence including text corresponding to the trigger. The second database may comprise personal data stored on the electronic device for a purpose other than text input.

### BRIEF DESCRIPTION OF THE DRAWINGS

For a better understanding of the present invention and to understand how the same may be brought into effect reference will now be made by way of example only to the accompanying drawings illustrating exemplary embodiments of the invention, in which:

FIG. 1 schematically illustrates a hand-portable electronic device 10 for user text entry;

FIG. 2 illustrates the automatic switching between databases in response to a trigger within a sequence of keystrokes being made by a user; and

FIG. 3 illustrates the automatic switching-off of predictive text input in response to a trigger within a sequence of keystrokes being made by a user.

### DETAILED DESCRIPTION OF PARTICULAR EMBODIMENTS OF THE INVENTION

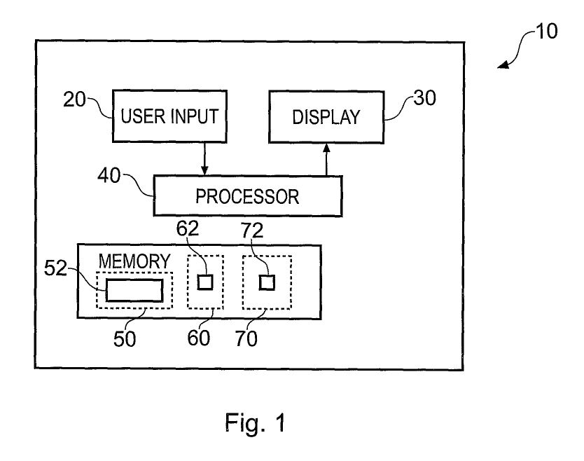

FIG. 1 schematically illustrates a hand-portable electronic device 10 for user entry of text. Examples of hand-portable electronic devices include mobile cellular telephones and personal digital assistants (PDAs).

The illustrated electronic device 10 includes a user input device 20; a display 30; a processor 40; a first memory 50 containing a database 52, a second memory 60 containing a set 62 of computer program instructions for the processor 40 and a third memory 70 comprising personal data 72. Although the first memory 40, second memory 60 and the third memory 70 are illustrated and described as being separate memories, it should be appreciated that they may also be separate portions of the same memory chip and the division between the portions may be physical or logical.

The processor 40 is connected to receive input from the user input device 20 and to provide output to the display 30. It is connected to read from and write to the memories 50, 60, 70.

The user input device 20 is any suitable user input device. It may be an ITU-T keypad. Each key of the keypad is associated with a numeral and/or a number of alphanumeric characters. A sequence of keystrokes made by a user consequently corresponds to a string of alphanumeric characters.

The first memory 50 stores a database 52. The database 52 stores a plurality of key identifier sequences and, associates with each key identifier sequence, a set of words whose spellings correspond to the key identifier sequence. The term “key identifier sequence” corresponds to the term as used in U.S. Pat. No. 5,818,437. The first memory 50 may also contain associated with each word a priority rating.

The first memory 50 also stores a set of disambiguating computer program instructions that enable the processor 40 to disambiguate a generated key identifier sequence into a word. The processor 40, when so enabled, generates an identifier sequence each time a character is added to the word string of alphanumeric characters being input by the user via the input device 20 and interrogates the database 52 using the generated key identifier sequence. The processor 40 receives in reply from the database 52 all or some of the words in the set of words whose spellings correspond to the generated key identifier sequence. The processor 40 presents on the display 30 one or more of the received words. The processor 40 may present, on the display 30, the word with the highest priority rating that corresponds to the key identifier sequence or the processor 40 may present a list of words, in priority rating order (highest first), that correspond to the key identifier sequence.

The third memory 70 comprises personal data 72. The personal data 72 comprises contact information such as names, addresses, email addresses, phone numbers etc. This data has typically been stored by a user over a period of time and thus generally contains words that have been selected by the user for storage. This personal data is used to augment the database 52 as described below.

The set 62 of computer program instructions control the operation of the processor 40 and the hand-portable device 10 as described below. The computer program instructions may be embodied on a physical entity such as a memory, data carrier such as a CD-ROM or DVD-ROM, or computer program product. The computer program instructions may be transferred to the device 10 via an electro-magnetic carrier signal.

The database 52 has a ‘standard’ condition and an ‘augmented’ condition. In the standard condition the database comprises the standard content of the database, perhaps also containing words that have been specifically added to the database by the user. This condition of the database may be optimized for normal prose. None of the words in the database 52, when in this condition, are taken from personal data 72 stored on the device.

In the augmented condition the database 52 comprises the content of the database in the standard condition but in addition it comprises a plurality of words that have been taken from the personal data 72 stored in the third memory 70. This condition of the database 52 may be optimized for entering Proper Nouns such as names and addresses. This optimization may be achieved, for example, by assigning to the words taken from the personal data a high priority rating. Different words taken from the personal data 72 may have different priority ratings.

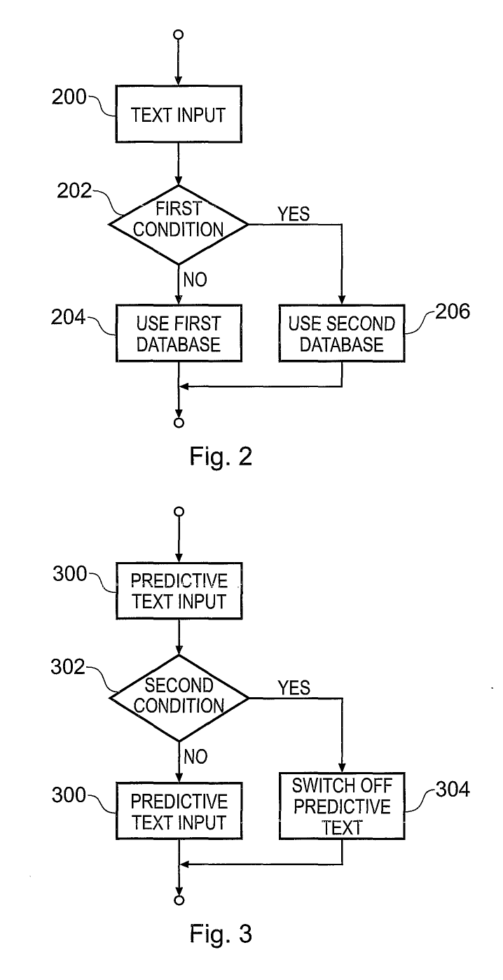

As illustrated in FIG. 2, the database 52 automatically switches 202 from the standard condition to the augmented condition in response to a trigger within the sequence of keystrokes being made 200 by a user. Thus the key identifier sequences generated before the trigger keystroke are provided to the ‘standard’ first database 204 and the key identifier sequences generated after the trigger keystroke are provided to the ‘augmented’ second database 206. The trigger is a keystroke or a series of keystrokes that satisfy the first condition.

The trigger may be, for example, an input corresponding to a character of predetermined form such as a capitalized letter appearing at the beginning of a word where the word is not at the beginning of a sentence clause. The trigger is therefore a keystroke that probably corresponds to the initial letter of a proper noun because it starts a word and does not follow a full-stop/period (i.e. “.”). In this example, the trigger is a character of predetermined form incorporated within the text input made by the user and also the first or second databases output, as opposed to a dedicated nonsense control keystroke or keystrokes that is used as a command but not included within the text output i.e. the trigger is present as a character in the input and also, in the same form, in the output.

In one embodiment, for a capitalized letter to operate as a trigger it must not be an initial letter in a series of capitalized letters. In this embodiment, as illustrated in FIG. 3, if a sequence of keystrokes that are input while the disambiguating function is on 300, satisfies 302 a second condition (e.g. two successive capitalized letters), then the disambiguating function is switched off 304 for that word and an identifier sequence is not generated each time a character is added to the string of alphanumeric characters or, alternatively, the database is used in the standard condition.

After the word that tripped the trigger has been confirmed by the user as part of the input text, then the condition of the database 52 may automatically revert to the standard condition. The database 52 is thus dynamically augmented only when needed. There is no need for a user to add contact names, for example, to the standard database and the selective augmentation of the database in response to a trigger does not interfere with the normal use of predictive text input.

As an example of the use of the described embodiment, in a device, in which either Finnish or English dictionary is set on, the user tries to input Chinese given name “Yiliang” by tapping 9-4-5-4-2-6-4. In this case, the device using only the database 52 in the standard condition may propose “Wilhani” and would not understand word “Yiliang” at all. However, according to the embodiment described above, the condition of the database 52 would change to the augmented condition when the user capitalizes the first letter. Thus the first entry the device would propose would be “Yiliang”.

In some languages (like English) there are also other nouns, which are capitalized in the written text. Such nouns are, for example, names of languages, days, places and months. In one embodiment of the invention, these nouns may also be automatically included in to the database 52 when it is in the augmented condition. In some languages, the capitalized pronouns may also be automatically included as words in the database 52 when it is in the augmented condition.

This augmented database may be updated at that same time the user starts to write text, or it may be created initially and updated every time the user adds new entries into dictionary or changes the personal data.

The description of the database 52 as having two conditions is intended to describe simultaneously an implementation in which two separate databases are used- one for standard and another for augmentation- and an implementation in which a single database is used but the searching of words from the personal data is somehow restricted in the standard condition.

Although embodiments of the present invention have been described in the preceding paragraphs with reference to various examples, it should be appreciated that modifications to the examples given can be made without departing from the spirit and scope of the invention.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A text input method for use in an electronic device, comprising: changing, in response to a trigger within an input sequence being made by a user, from a first text input method to a second text input method, wherein the second text input method displays text corresponding to the input sequence including text corresponding to the trigger.

2. The method as claimed in claim 1, wherein the first method involves searching, on the basis of an input sequence being made by a user, for words in a first database and displaying at least one word resulting from the search and the second method involves searching, on the basis of an input sequence being made by a user, for words in a second database and displaying at least one word resulting from the search.

3. The method as claimed in claim 2, wherein the first database comprises a first plurality of words and the second database comprises a second, different plurality of words.

4. The method as claimed in claim 2, wherein at least some of the second plurality of words are taken from personal data stored on the device.

5. The method as claimed in claim 2, wherein none of the words in the first database are taken from personal data stored on the device.

6. The method as claimed in claim 2, further comprising augmenting the first database using personal data stored on the device for a purpose other than text input to form the second database.

7. The method as claimed in claim 2, wherein words in the second database have at least a high priority or a lower priority and words in the second database taken from personal data stored on the device are given a high priority.

8. The method as claimed in claim 4, wherein the personal data comprises contact information.

9. The method as claimed in claim 4, wherein the personal data comprises names.

10. The method as claimed in claim 2, wherein the first database has a different prioritization of words compared to the second database.

11. The method as claimed in claim 7, wherein the priority of a word controls the likelihood that that word will result from a search.

12. The method as claimed in claim 7, wherein the priority of a word controls the order in which words resulting from a search are displayed.

13. The method as claimed in claim 2, wherein the change from the first text input method to the second text input method is temporary.

14. The method as claimed in claim 2, wherein the first and second databases associate with each of a plurality of identifier sequences a set of words whose spellings correspond to the respective key identifier sequence, and searching for words in the database comprises:
generating an identifier sequence based on the input sequence; and
providing the generated identifier sequence as input to the database, which returns at least one word from the set of words whose spelling corresponds to the generated key identifier sequence.

15. The method as claimed in claim 1, wherein the trigger is an input corresponding to a character or characters of predetermined form.

16. The method as claimed in claim 1, wherein the trigger is an input corresponding to a character of predetermined form within but not at the beginning of a clause.

17. The method as claimed in claim 1, wherein the trigger is an input corresponding to a character of predetermined form at the beginning of word.

18. The method as claimed in claim 15, wherein the character of predetermined form is any capitalized letter.

19. The method as claimed in claim 18, wherein the character of predetermined form is a capitalized letter followed by an non-capitalized letter.

20. The method as claimed in claim 1, wherein the first method involves searching, on the basis of an input sequence being made by a user, for words in a first database and displaying at least one word resulting from the search and the second method involves displaying the input sequence being made by a user.

21. The method as claimed in claim 20, wherein the trigger is an input sequence being made by the user that includes an acronym.

22. The method as claimed in claim 20, wherein the trigger is an input sequence of capitalized letters at the beginning of a word input by a user.

23. The method as claimed in claim 1, wherein the input sequence corresponds to a string of alphanumeric characters.

24. A computer readable medium stored with program instructions executable by a processor for: automatically changing, in response to a trigger within an input sequence being made by a user, a first text input method to a second text input method, wherein the second text input method displays text corresponding to the input sequence including text corresponding to the trigger.

25. An electronic device comprising:
a user input device for user entry of text;
a display;
a processor;
memory storing personal data, a database comprising words wherein at least some of the words in the database are taken from the stored personal data, and a set of processor instructions which cause the processor:
to change, in response to a trigger within an input sequence being made by a user via the input device, from a first text input method to a second text input method, wherein the second text input method displays text corresponding to the input sequence including text corresponding to the trigger.

26. A text input method for use on an electronic device comprising:
searching, on the basis of an input sequence being made by a user, for words in a database that has a first condition and a second alternative condition;
changing the condition of the database from the first condition to the second condition in response to a trigger within the input sequence; and
displaying at least one word resulting from the search that includes text corresponding to the trigger.

27. A computer readable medium stored with program instructions executable by a processor for:
searching for words in the database on the basis of the input sequence being made by a user;
changing the database in response to a predetermined trigger within an input sequence being made by a user;
searching for words in the changed database on the basis of the input sequence being made by a user; and
displaying at least one word resulting from the search that includes text corresponding to the trigger.

28. An electronic device comprising:
a user input device for user entry of text;
a display;
a processor;
memory storing personal data, a database comprising words wherein at least some of the words in the database are taken from the stored personal data, and a set of processor instructions which cause the processor:
to change the database in response to a predetermined trigger within an input sequence being made by a user via the input device, to search for words in the database on the basis of the input sequence being made by the user via the user input device; and
to display via the display at least one word resulting from the search that includes text corresponding to the trigger.
